(19) United States
(12) Patent Application Publication
(10) Pub. No.: US 2014/0149942 A1
(43) Pub. Date: May 29, 2014

(54) SYSTEM AND METHOD FOR ACTIONABLE REPORTING OF A RADIOLOGY IMAGE STUDY

(71) Applicant: Cleon Hill Wood-Salomon, St. Jacobs (CA)

(72) Inventor: Cleon Hill Wood-Salomon, St. Jacobs (CA)

(21) Appl. No.: 13/684,461

(22) Filed: Nov. 23, 2012

(51) Int. Cl. G06F 3/0482

(52) U.S. Cl. CPC G06F 3/0482
USPC 715/840

(57) ABSTRACT

A system and method for interfacing a radiologist to a radiology system is disclosed. A signature code area may display input buttons that may be used to permit a radiologist to generate a radiology image report and to classify a finding of the radiology image report, assign an alert to the radiology image report, and generate a follow-up status for the radiology image report. Furthermore, a display of the radiology workflow statistics may be provided and contact information associated with a referring physician of a selected radiology image report may be provided.

### FIELD

The present disclosure relates to a system and method for interfacing physicians to facilitate workflow. In some embodiments, the present disclosure relates to a system and method for actionable reporting in a radiology system.

### BACKGROUND

Conventional radiology departments typically allocate work based on radiologists affiliated with the hospital. For example, a radiology department of a specific hospital may have a certain number of radiologists. Radiology work, which may include reading one more studies of patients at the specific hospital, may be conventionally assigned to the various radiologists or medical professionals employed at the specific hospital's radiology department.

However, recent trends in the medical industry have involved the merging of various medical practice groups or departments. For example, radiology practice groups of a first hospital have been merged with radiology practice groups of one or more other hospitals or medical groups. As such, radiology practice groups may now comprise a plurality of radiologists over a plurality of locations (e.g., hospitals or practice groups). Thus, the radiologists and a referring physician who is requesting the completion of a radiology image study to be performed by a radiologist may each reside or work in different locations.

As such, it is desirable to develop systems and methods to interface a radiologist and referring physicians with a radiology system workflow. The interface for the radiologist may display information to facilitate the completion of a report for a radiology image study as well as to facilitate the management of the radiologist's workflow.

### SUMMARY

The present disclosure introduces systems and methods for interfacing physicians to a radiology system.

The system or method may comprise displaying, in a signature code area of a display, input buttons for generating and signing a report for a radiology exam request. An input may be received by the radiologist via the input buttons to generate a report and to permit the radiologist to perform at least one of classifying a finding for the report, generating one or more alerts associated with the report, or generating a follow-up status associated with the report. Furthermore, the system or method may display, in a stats display area of the display, at least one icon that displays status information about reports and that displays, when initiated, means to manage reports and workflow for the radiologist. Furthermore, the system or method may display, in a study contact display area of the display, information, including contact information, for a selected report.

In some embodiments of the disclosure, the system or method may further display workflow navigation buttons to control navigation and input to generate a radiologist report.

In some embodiments, a classified finding for the report may be generated by the radiologist through the input buttons to generate a finding of at least one of significant, not significant, indeterminate, or normal.

In some embodiments, the receiving an input to generate one or more alerts associated with the report comprises receiving input from the buttons from a radiologist to input to a report an alert of at least one of the type of red, orange, or yellow.

In some embodiments of the disclosure, the receiving input to generate a follow-up status associated with the report comprises receiving input from the buttons from a radiologist to input to a report a follow-up status or a no follow-up status.

In some embodiments, the displaying, in a stats display area, at least one icon comprises displaying a plurality of icons that each indicate a number of reports associated with a red alert, an orange alert, and a yellow alert and to initiate, through the respective icons, additional information associated with the reports.

In some embodiments of the disclosure, the displaying, in a stats display area, at least one icon comprises displaying a plurality of icons to display an indication for at least one of unsigned reports, wet reads, peer review or shift RVU.

In some embodiments, the displaying, in a study contact display area, information further comprises displaying an icon to permit access to a key image.

In some embodiments, the displaying, in a study contact display area, information further comprises displaying at least one icon to indicate at least one of an indication for a wet read or a prelim.

In some embodiments, the displaying, in a study contact display area, information further comprises displaying at least one icon to indicate whether a report has been acknowledged by a referring physician.

### BRIEF DESCRIPTION OF THE DRAWINGS

The novel features of the disclosure are set forth in the appended claims. However, for purpose of explanation, several embodiments of the disclosure are set forth in the following figures.

FIG. 1 illustrates an example environment for actionable reporting of a radiology image study in accordance with some embodiments of the disclosure.

FIG. 2 is a flow diagram of an example method for managing a diagnostic imaging report in accordance with some embodiments.

FIG. 3 is a block diagram of a signature pad to be used for actionable reporting of a radiology image study in accordance with some embodiments of the disclosure.

FIG. 4 is a flow diagram of an example method for using a signature pad for actionable reporting of a radiology image study in accordance with some embodiments of the disclosure.

FIG. 5 is a flow diagram of an exemplary method for authoring a diagnostic imaging report and communicating with a referring physician in accordance with some embodiments.

FIG. 6 is a diagram illustrating a graphical user interface for displaying a radiologist work list in accordance with some embodiments.

FIG. 7 is a diagram illustrating a graphical user interface for displaying an actionable report of a radiology image study in accordance with some embodiments of the disclosure.

FIG. 8 illustrates an example method for interacting with a signature pad in accordance with some embodiments.

FIG. 9 depicts a diagram illustrating an exemplary computing system environment for execution of the operations comprising various embodiments of the disclosure.

### DETAILED DESCRIPTION

The systems and methods disclosed herein relate to generating an actionable report for a radiology image study.

In the following detailed description, numerous specific details are set forth in order to provide a thorough understanding of the present disclosure. However, it will become obvious to those skilled in the art that the present disclosure may be practiced without these specific details. The description and representation herein are the common means used by those experienced or skilled in the art to most effectively convey the substance of their work to others skilled in the art. In other instances, well known methods, procedures, and systems have not been described in detail to avoid unnecessarily obscuring aspects of the present disclosure.

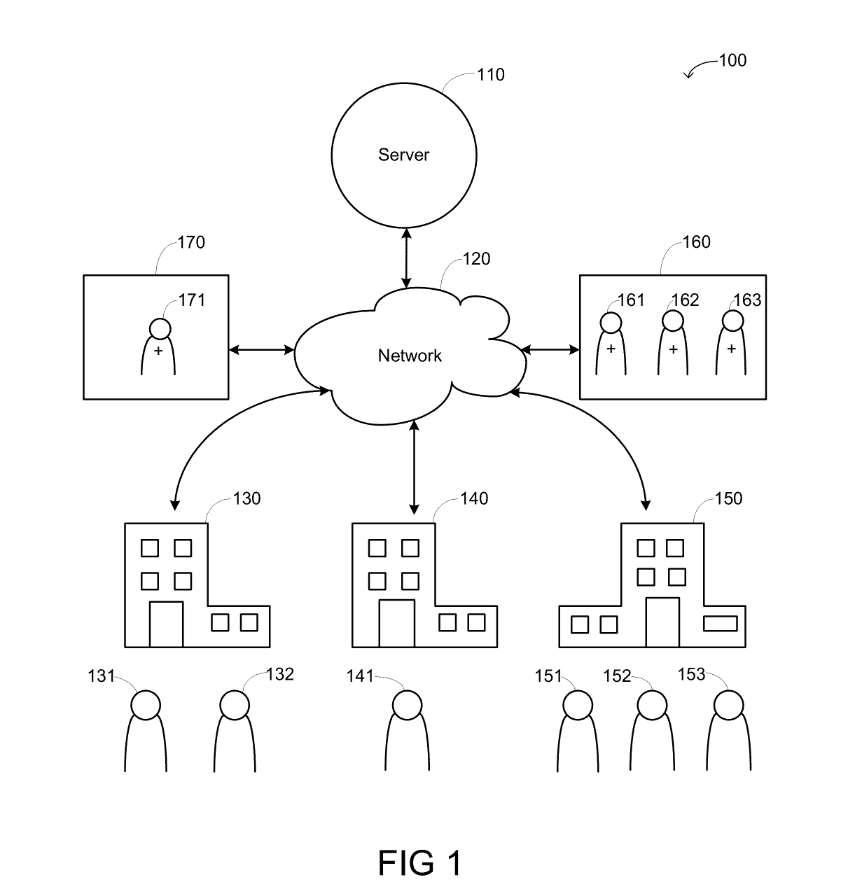

FIG. 1 illustrates an example environment 100 for actionable reporting of a radiology image study in accordance with some embodiments. In general, the environment 100 may comprise a plurality of medical locations and a plurality of medical professionals such that a first medical professional (e.g., a referring physician) at a first medical location may request a diagnostic image study (e.g., a radiology work or image study) to be performed by a second medical professional (e.g., a radiologist) at a second medical location.

As shown in FIG. 1, the environment 100 may comprise a server 110 and medical professional locations 130, 140, 150, 160, and 170. Each of the server 110 and medical professional locations 130, 140, 150, 160, and 170 may be connected to or coupled to a network 120 (e.g., the Internet) such that each medical professional location communicates with server 110 over the network 120 or between any two locations (e.g., a radiologist at a first medical professional location communicating with a referring physician at a second medical professional location, etc.).

In some embodiments, one or more of the medical professional locations 130, 140, 150, 160, and 170 may be associated with one or more patients (e.g., a patient associated with a radiology image study or a radiology work study and associated with a referring physician). For example, the medical professional locations 130, 140, and 150 may be a hospital, doctor's office, or any other medical practice location. In some embodiments, medical professional locations 130, 140, and 150 may each correspond to a different location or jurisdiction. For example, medical professional location 130 may be in a first state (e.g., the state of Washington), medical professional location 140 may be in a second state (e.g., the state of Oregon), and medical professional location 150 may be in a third state (e.g., the state of California). As such, each of the medical professional locations 130, 140, and 150 may be in a different jurisdiction and/or different location. Each of the medical professional locations 130, 140, and 150 may be associated with one or more medical patients. In some embodiments, each of the medical professional locations 130, 140, and 150 may be further associated with a referring physician. For example, medical professional location 130 may be associated with referring physicians 131 and 132, medical professional location 140 may be associated with referring physician 141, and medical professional location 150 may be associated with referring physicians 151, 152, and 153. In some embodiments, each of the referring physicians 131, 132, 141, 151, 152, and 153 may be associated with at least one radiology image study from at least one medical patient. For example, each of the referring physicians may request a radiology image study (e.g., a work study) to be completed by a radiologist for at least one medical patient, as will be described in further detail below.

As such, each medical professional location may be associated with one or more medical patients where each patient may be associated with one or more radiology image studies and one or more referring physicians who are requesting the one or more radiology image studies. The medical professional locations may be associated with one or more locations.

As shown in FIG. 1, the environment 100 may comprise one or more medical professional locations. For example, medical professional location 160 may be a first radiologist group in a first state, location, or jurisdiction and medical professional location 170 may be a second radiologist group in a second state, location, or jurisdiction. Each medical professional location 160 and 170 may be associated with one or more medical professionals. For example, a medical professional location 170 may be associated with a radiologist 171. Moreover, the medical professional location 160 may be associated with a radiologist 161, a second radiologist 162, and a third radiologist 163. As such, in some embodiments, each of the radiologists 161, 162, 163, and 170 may generate an actionable report for a radiology image study, as will be described in further detail below.

As such, in some embodiments, the environment 100 may comprise one or more medical professional locations that may be associated with one or more medical patients (e.g., radiology patients) and one or more referring physicians or one or more radiologists. In some embodiments, each of the radiology patients may be associated with a radiology image study (e.g., a series of radiology images) that may have originated from or be associated with a referring physician who has requested the radiology image study to be performed by a radiologist. In some embodiments, a radiology image study from a hospital (e.g., medical professional location 130, 140, and/or 150) may be communicated to the server 110 over the network 120. For example, a radiology patient may be associated with or have a radiology image study done at a hospital. Each of the radiology image studies from a referring physician associated with the radiology patients may be communicated or sent to the server 110 over the network 120. In some embodiments, the server 110 may store each of the radiology work studies into a database and/or a repository of radiology work studies. Moreover, in some embodiments, the server 110 may assign, relay, communicate, and/or send one or more of the radiology work studies received from one or more hospitals to at least one radiologist at a medical professional location (e.g., medical professional location 160 and/or 170) or to a specific radiologist (e.g., radiologists 161, 162, 163, and/or 171). In some embodiments, the completion of the radiology image study by a radiologist may involve generating an actionable report, as will be discussed in further detail below.

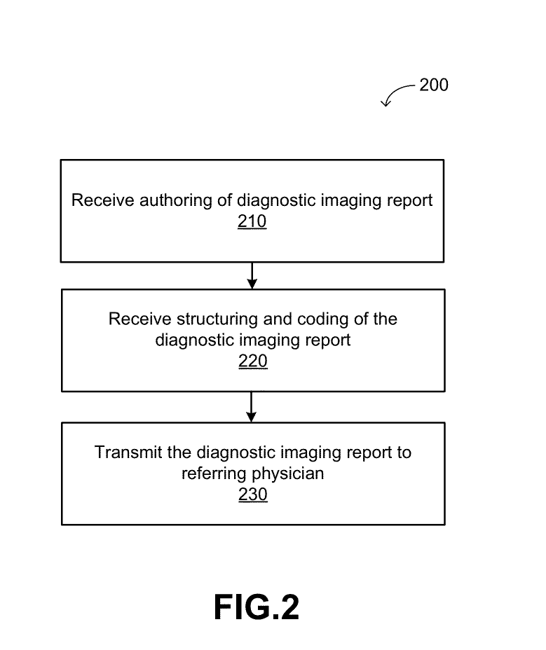

FIG. 2 is a flow diagram of a method 200 for managing a diagnostic imaging report (e.g., a radiology image study report) in accordance with some embodiments. In general, a radiologist interfacing with a radiology workflow system may use the method 200.

As shown in FIG. 2, at block 210, an authoring of a diagnostic imaging report (e.g., an actionable report for a radiology image study) may be received. In some embodiments, the authoring of the diagnostic imaging report may comprise a radiologist authoring and/or dictating a radiology image study report from a medical patient and/or a referring physician. At block 220, the method may receive a structuring and coding of the diagnostic imaging report. For example, the radiologist may structure the radiology image report and associate the radiology image study report with a code. Further details with regard to structuring and associating a code with a radiology image report are discussed in further detail below. At block 230, the diagnostic imaging report may be reported to the referring physician. For example, the radiologist may complete authoring a radiology image study report and associate a code to the radiology image study report and the completed radiology image study report may be transmitted to a workflow associated with the referring physician.

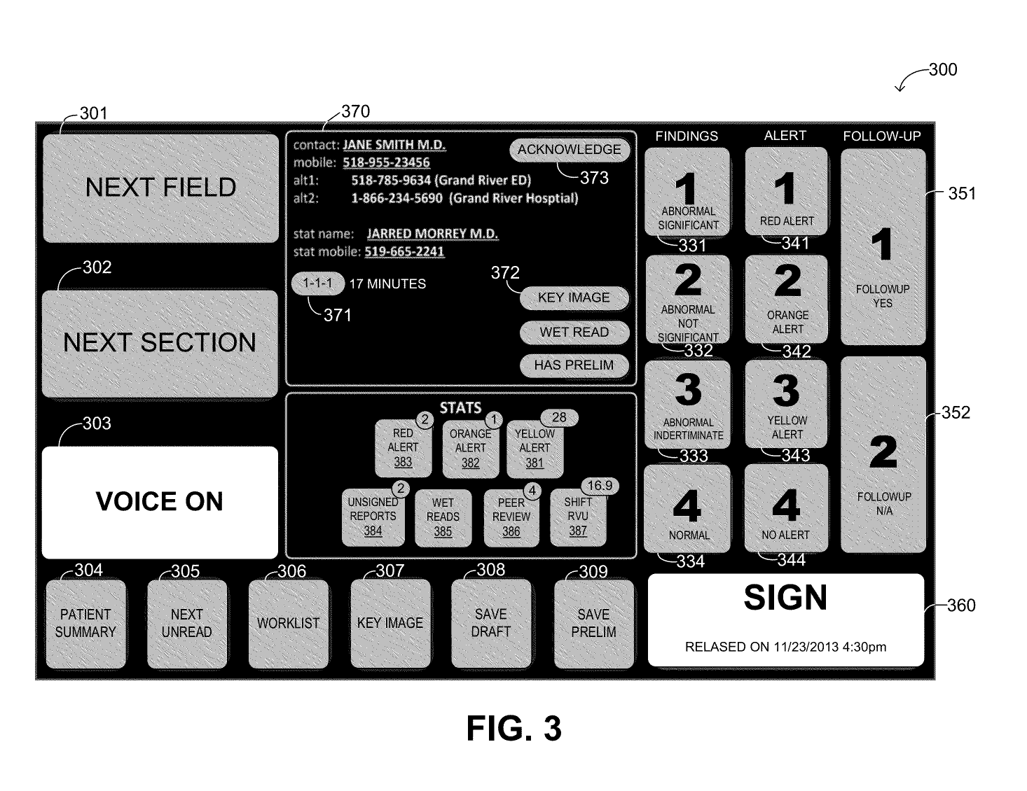

FIG. 3 is a block diagram of a signature pad 300 to be used for actionable reporting of a radiology image study in accordance with some embodiments of the disclosure. In general, the signature pad 300 may be used by a radiologist to author a radiology image study report, to view radiology workflow information associated with the radiologist, to view information associated with a currently selected radiology image study, and to sign a radiology image study report.

As shown in FIG. 3, the signature pad 300 may comprise workflow navigation buttons 301, 302, and 303. In some embodiments, the workflow navigation buttons may be used to control the navigation and input to generate or author a radiology image study report (e.g., an actionable report). In some embodiments, the signature pad 300 may be coupled to a voice recorder or voice dictating hardware or software module and the workflow navigation buttons may be used to control the dictating or authoring of a radiology image study report by a radiologist. For example, the workflow navigation button 301 may comprise a ‘next field’ functionality, the workflow navigation button 302 may comprise a ‘next section’ functionality, and the workflow navigation button 303 may comprise a ‘voice on’ functionality. In the same or alternative embodiments, the clicking or interaction with the ‘voice on’ functionality of the workflow navigation button 303 may activate a voice recording or voice dictating software for the radiologist to author a radiology image study report, the ‘next field’ functionality of the workflow navigation button 301 may be used by the radiologist to navigate through different fields of a radiology image study report, and the ‘next section’ functionality of the workflow navigation button 302 may be used by the radiologist to navigate through different sections of a radiology image study report.

As such, the signature pad 300 may comprise one or more workflow navigation buttons. For example, the workflow navigation buttons may be used by a radiologist to author a radiologist image study report. In some embodiments, the workflow navigation buttons may be used to control audio or voice recording from a radiologist and to specify which sections of a radiologist image study report the radiologist is dictating. Thus, the signature pad 300 comprises a display of workflow navigation buttons used by a radiologist to author a radiologist image study report (e.g., an actionable report).

As shown in FIG. 3, the signature pad 300 may further comprise contact display area 370. In some embodiments, the contact display area 370 may display the contact information of a referring physician associated with a radiology image study that is currently selected or being dictated by the radiologist. For example, the contact display area 370 may display the contact information of the referring physician of which the radiologist is currently authoring a radiology image study report from by using the workflow navigation buttons 301, 302, and/or 303. In some embodiments, the contact display area 370 may display the contact name of the referring physician, a mobile phone number of the referring physician, as well as alternative contact numbers. For example, the contact display area 370 may comprise a contact phone number of the medical department associated with the referring physician and the contact phone number of the hospital associated with the referring physician. In some embodiments, the contact display area 370 may comprise an acknowledgement indication 373. In some embodiments, the acknowledgement indication 373 may indicate whether the referring physician has acknowledged the radiology image study report as completed and signed by the radiologist, as will be discussed in further detail below. The contact display area 370 may further comprise an acknowledgment code 371, as will be further discussed, and a key image button 372. In some embodiments, the key image button 372 may be selected to display key images of a radiology image study that have been included by the radiologist into the radiology work study report. As such, the user interface of the signature pad 300 may comprise a ‘key image’ icon that may be displayed and then selected to display one or more key images that may have been selected for the radiology image study report. For example, in some embodiments, the radiologist using the signature pad 300 may be authoring a radiology image study report based on viewing a plurality of radiology images. As such, the key images displayed when the ‘key image’ icon is selected may include a subset of the radiology images that have been identified or selected by the radiologist when authoring the radiology image study report. In some embodiments, the contact display area 370 of the signature pad 300 may further comprise a ‘wet read’ icon or button and a ‘has prelim’ icon or button. In some embodiments, the ‘wet read’ icon or button and the ‘has prelim’ icon or button may indicate whether the currently selected radiology image study is associated with a wet read and/or a preliminary report. In some embodiments, the ‘acknowledge’ icon or button 373 may indicate whether the referring physician has acknowledged the currently selected radiology image study report that has been signed by a radiologist.

As such, the signature pad 300 may comprise a contact display area that comprises contact information of a referring physician of a selected radiology image study report, whether the referring physician has acknowledged a radiology image study report, and key images of a radiology image study report.

As shown in FIG. 3, the signature pad 300 may further comprise a statistics or stats display area. In some embodiments, the stats display area may comprise one or more icons or buttons that display status information concerning radiology image study reports and display the radiology image study reports or a user interface of the radiologist's workflow. As such, the stats display area may be used by a radiologist to manage the radiologist's reports and workflow. In some embodiments, the stats display area may comprise a red alert icon or button 383, orange alert icon or button 382, and a yellow alert icon or button 381. In some embodiments, the radiologist may use the signature pad 300 to classify or code a radiology image study report and the classification or code may result in the radiology image study report being classified as one of a red alert, orange alert, or yellow alert, as will be discussed in further detail below. In some embodiments, the red alert icon or button 383, the orange alert icon or button 382, and the yellow alert icon or button 381 may further display a numerical value to indicate a number of radiology image study reports that have been signed by the radiologist that have not yet been acknowledged by a corresponding referring physician. In some embodiments, the stats display area may further comprise an unsigned reports icon 384 that may be selected to display any unsigned radiology image study reports that have not yet been signed by the radiologist using the signature pad 300, the wet reads icon 385 may be used to display any wet reads that are currently outstanding for the radiologist using the signature pad 300, the peer review icon 385 may be used to display any peer review radiology image studies that need to be completed by the radiologist using the signature pad 300, and the shift RVU icon 387 may indicate a number of Relative Value Units (RVUs) that the radiologist using the signature pad 300 has obtained during the current shift.

As such, the signature pad 300 may display statistics regarding the radiologist who is currently using the signature pad 300. For example, the signature pad 300 may display statistics regarding radiology image study reports that the radiologist has signed as well as additional work studies that must be completed by the radiologist.

As shown in FIG. 3, the signature pad 300 may further comprise additional workflow navigation icons or buttons. For example, the signature pad 300 may display a patient summary icon 304 to display patient summary information of the medical patient associated with the currently selected radiology image study (e.g., the radiology image study that the radiologist is currently authoring). Furthermore, the signature pad 300 may comprise a next unread icon 305 to view the next unread (e.g., yet to be authored as an actionable report) radiologist image study that may be completed by the radiologist, a work list icon 306 to show a work list comprising one or more radiology image studies that have been assigned to the radiologist for completing a radiology image study report, a key image icon 307 to display key images, a save draft icon 308 to save the currently authored radiology image study report, and a save preliminary icon 309.

As such, the signature pad 300 may further comprise icons or buttons to manage the radiologist's overall workflow. For example, the radiologist's workflow may comprise a plurality of radiology image studies that must be completed by the radiologist (e.g., the radiologist must author and sign a radiology image study report). The signature pad 300 may comprise workflow navigation buttons to progress through the radiologist's assigned radiology image studies in order to facilitate the management of the radiologist's workflow.

As shown in FIG. 3, the signature pad 300 may further comprise a signature code area 360 comprising a plurality of buttons. In some embodiments, the buttons (e.g., input buttons) may be used to generate and sign a report for a radiology image study report (e.g., a report for a radiology exam request from a referring physician). In some embodiments, the buttons may be used to permit the radiologist to classify a finding of the radiology image study report, generate an alert associated with the radiology image study report, and generate a follow-up status associated with the radiology image study report. For example, a finding associated with the radiology image study report may be classified based on a selection of one of the buttons 331, 332, 333, and 334. In some embodiments, the button 331 may indicate that the finding (e.g., a medical finding from the radiologist) of the radiology image study has resulted in an ‘abnormal significant’ finding, the button 332 may indicate that the finding of the radiology image study is an ‘abnormal not insignificant’ finding, the button 333 may indicate that the finding of the radiology image study is an ‘abnormal indeterminate’ finding, and the button 334 may be selected to indicate that the finding of the radiology image study is a ‘normal’ finding. In the same or alternative embodiments, an ‘abnormal significant’ finding may indicate a finding was recognized relating to the reason that the referring physician requested the study and may impact the treatment for the medical patient, a ‘not significant’ finding may indicate a finding that was recognized that does not likely impact the care for the medical patient, an ‘indeterminate’ finding may indicate a finding that was recognized but a conclusion could not be reached, and a ‘normal’ finding may indicate a finding where nothing unusual or remarkable with regard to the medical patient was found from the radiology image study. In some embodiments, the signature code area 360 may further comprise alert buttons 341, 342, 343, and 344. In the same or alternative embodiments, the button 341 may indicate a ‘red alert’ status for the radiology image study, the button 342 may indicate an ‘orange alert’ status for the radiology image study, the button 343 may indicate a ‘yellow alert’ status for the radiology image study, and the button 344 may indicate a ‘no alert’ status for the radiology image study. In some embodiments, the alert status may define an amount of time for the referring physician to acknowledge a signed radiology image study report. For example, a ‘red alert’ status may allow for a first elapsed amount of time, a ‘yellow alert’ status may allow for a second elapsed amount of time, and an ‘orange alert’ status may allow for a third elapsed amount of time for the referring physician to acknowledge the radiology image study report. Furthermore, the first elapsed time may be shorter than the second elapsed time and the second elapsed time may be shorter than the third elapsed amount of time. In some embodiments, if the elapsed time has passed, then the radiology system may transmit a reminder (e.g., by SMS, pager, email) to the referring physician to acknowledge the actionable report.

In some embodiments, the signature area code 360 may further comprise follow-up buttons 351 and 352. In some embodiments, the follow-up button 351 may be used to indicate a ‘follow-up’ status for the radiology image study and the button 352 may indicate a ‘no follow-up’ status for the radiology image study.

As such, the signature pad 300 may comprise a plurality of buttons as indicated above. In some embodiments, the buttons may indicate a numerical value. For example, the radiologist using the signature pad 300 may need to select at least one button from each of the findings buttons, alert buttons, and follow-up buttons. In some embodiments, the combination of the three buttons selected may be considered a code. As such, each radiology image study report that is signed by the radiologist is also associated with a three-digit code. In some embodiments, the three-digit code may be used to indicate an amount of time for a referring physician to acknowledge the radiology image study report that has been signed by the radiologist.

As shown in FIG. 3, the signature pad 300 may further comprise a signature code area 360. In some embodiments, the signature code area 360 may comprise a button or icon to be selected by the radiologist using the signature pad 300 to sign the radiology image study report currently being authored and/or displayed in the signature pad 300. In some embodiments, the signing of the radiology image study report may result in the releasing of the radiology image study report to the corresponding referring physician (e.g., the physician indicated in the contact display area 370). In some embodiments, the signature code area 360 may further indicate a date and time as to when the radiology image study report was released to the referring physician.

As such, the signature pad 300 may comprise a user interface to facilitate the workflow for a radiologist. The user interface may be used to display buttons to author or generate a radiology image study report, classify the radiology image study report, display workflow statistics of the radiologist's workflow, and display contact information of the referring physician associated with a radiology image study report.

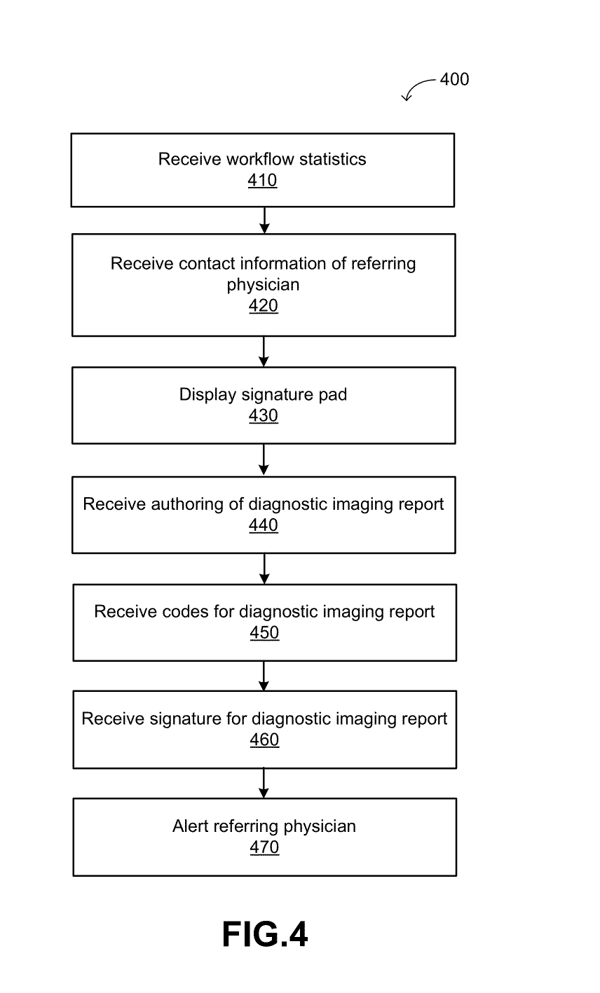

FIG. 4 is a flow diagram of an example method 400 for using a signature pad (e.g., signature pad 300) for actionable reporting of a radiology image study in accordance with some embodiments of the disclosure. In general, the method 400 may receive information from a radiologist and alert a referring physician.

As shown in FIG. 4, the method 400, at step 410, may receive workflow statistics. For example, radiology workflow statistics of a radiologist may be received. In some embodiments, the workflow statistics may comprise a number of red alert, orange alert, and yellow alert status radiology image study reports have yet to be acknowledged by a referring physician, a number of unsigned reports remaining for the radiologist, and other radiology workflow statistics as previously described. At step 420, contact information of a referring physician may be received. For example, a contact phone number and/or email of the referring physician associated with a radiology image study may be received. At step 430, a signature pad (e.g., the signature pad 300) may be displayed and the workflow statistics and contact information of the referring physician may be displayed. At step 440, the authoring of a diagnostic imaging report (e.g., radiology image study) may be received. For example, the authoring of a radiology image study report may be received from the use of workflow navigation buttons to control a voice dictating software and/or hardware. Furthermore, at step 450, codes may be received for the diagnostic imaging report. For example, a finding code, alert code, and follow-up code may be received to create a three-digit code for a radiology image study report. Furthermore, at step 460, a signature may be received for the diagnostic imaging report (e.g., the radiology image study report). For example, a selection of the sign button 360 of the signature pad 300 may be received. In response to the selection of the sign button, at step 470, a referring physician may be alerted. For example, the referring physician may be alerted by the use of the contact information received at step 420.

As such, a workflow using the signature pad 300 may be received. Workflow statistics of a radiologist may be received and displayed to a user (e.g., the radiologist). Furthermore, contact information of a referring physician associated with a currently selected radiology image study may be received and displayed to the user. Input may be received from the user to author the currently selected radiology image study and the radiology image study may be classified with a three-digit code by using the signature pad 300. Furthermore, the radiology image study may be signed by the radiologist. In addition, the signature pad 300 may further be used to navigate through the radiologist's total workflow of additional radiology work studies needing to be read.

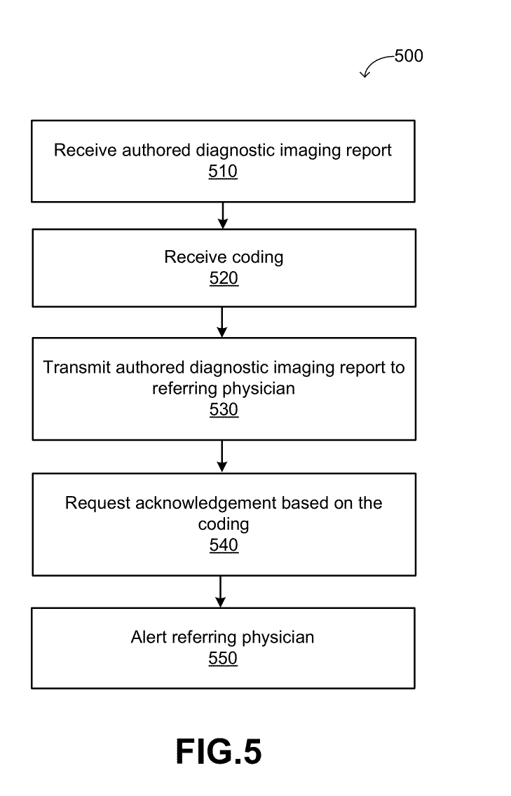

FIG. 5 is a flow diagram of an exemplary method 500 for authoring a diagnostic imaging report and communicating with a referring physician in accordance with some embodiments.

As shown in FIG. 5, the method 500 may receive, at step 510, an authored diagnostic imaging report. For example, the authored diagnostic imaging report may comprise a signed radiology image study report (e.g., actionable report) performed by a radiologist. At step 520, a code (e.g., a three-digit code) associated with the radiology image study report may be received. In some embodiments, at step 530, the radiology image study report may be transmitted to a referring physical who requested the radiology image study report of one or more radiology images of a medical patient. Furthermore, at step 540, an acknowledgment may be requested based on the three-digit code from step 520. For example, the acknowledgement may comprise a verbal or electronic acknowledgement from the referring physician. In some embodiments, the type of the three-digit coding may determine an amount of time that may lapse for the referring physician to acknowledge the radiology image study report. In some embodiments, if the three-digit coding results in the radiology image study report comprising a ‘red alert’ status, then the referring physician may be notified by a phone call, pager, or SMS text, but for a ‘yellow alert’ or other, the referring physician may be notified (at step 550) or alerted by an email or other form of communication.

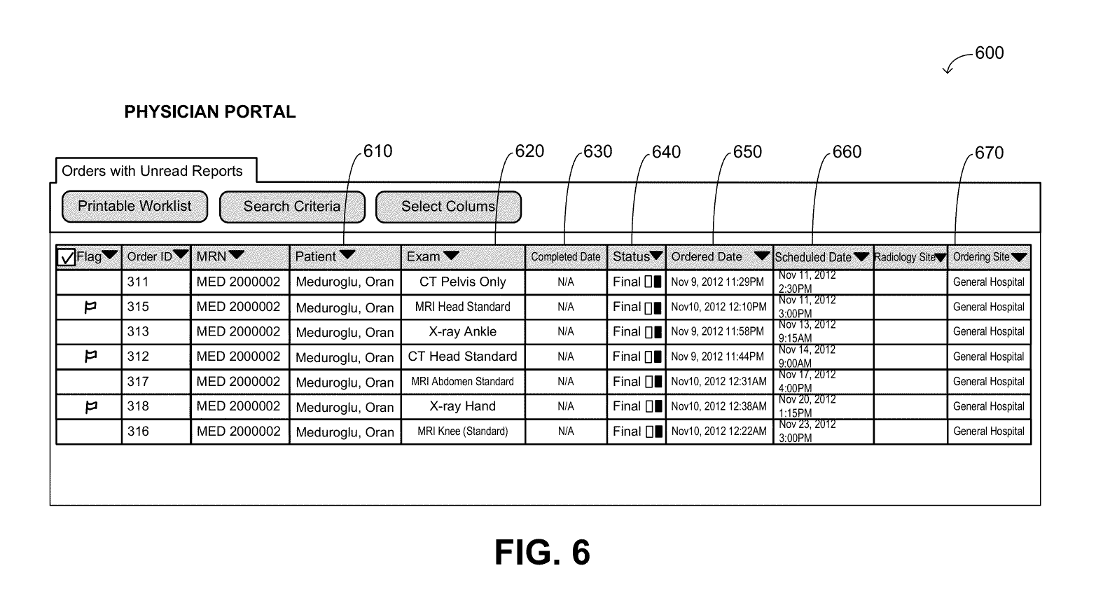

FIG. 6 is a diagram illustrating a graphical user interface 600 for displaying a radiologist work list in accordance with some embodiments. In general, the graphical user interface 600 may display a plurality of actionable reports generated by a radiologist.

As shown in FIG. 6, the graphical user interface 600 may display a plurality of radiology image study reports signed by a radiologist (e.g., actionable reports). In some embodiments, the graphical user interface 600 may display information with regard to each of the radiology image study reports. For example, the graphical user interface 600 may comprise a patient field 610, exam field 620, completion date field 630, status field 640, order date field 650, schedule date 660, a radiology site field, and an ordering site field 670. Each of the fields may display corresponding information for each of the radiology image study reports. In some embodiments, the graphical user interface 600 may display unread actionable reports from a radiologist. For example, the graphical user interface 600 may display actionable reports (e.g., signed radiology image study reports) that have been released and delivered to a corresponding referring physician. In some embodiments, each actionable report that has been released to a referring physician may need to be acknowledged by the referring physician. For example, in part of the radiology workflow, the referring physician may be required to indicate that an actionable report has been received and/or read. As such, the graphical user interface 600 may display the actionable reports that have been transmitted to a referring physician and that have not yet been read or acknowledged by the referring physician. As such, the graphical user interface 600 may display unread actionable reports. Furthermore, the graphical user interface 600 may further be used to display actionable reports that have been read or any other actionable report or pending radiology image study currently pending for the radiologist.

In some embodiments, the graphical user interface 600 may be opened in response to a user of the signature pad selecting a work list icon 306, red alert icon 383, orange alert icon 382, yellow alert icon 381, unsigned reports icon 384, wet reads icon 385, and peer review icon 386. As such, the graphical user interface 600 displaying a plurality of actionable reports and/or radiology image study reports may be displayed in response to a user input from the signature pad 300.

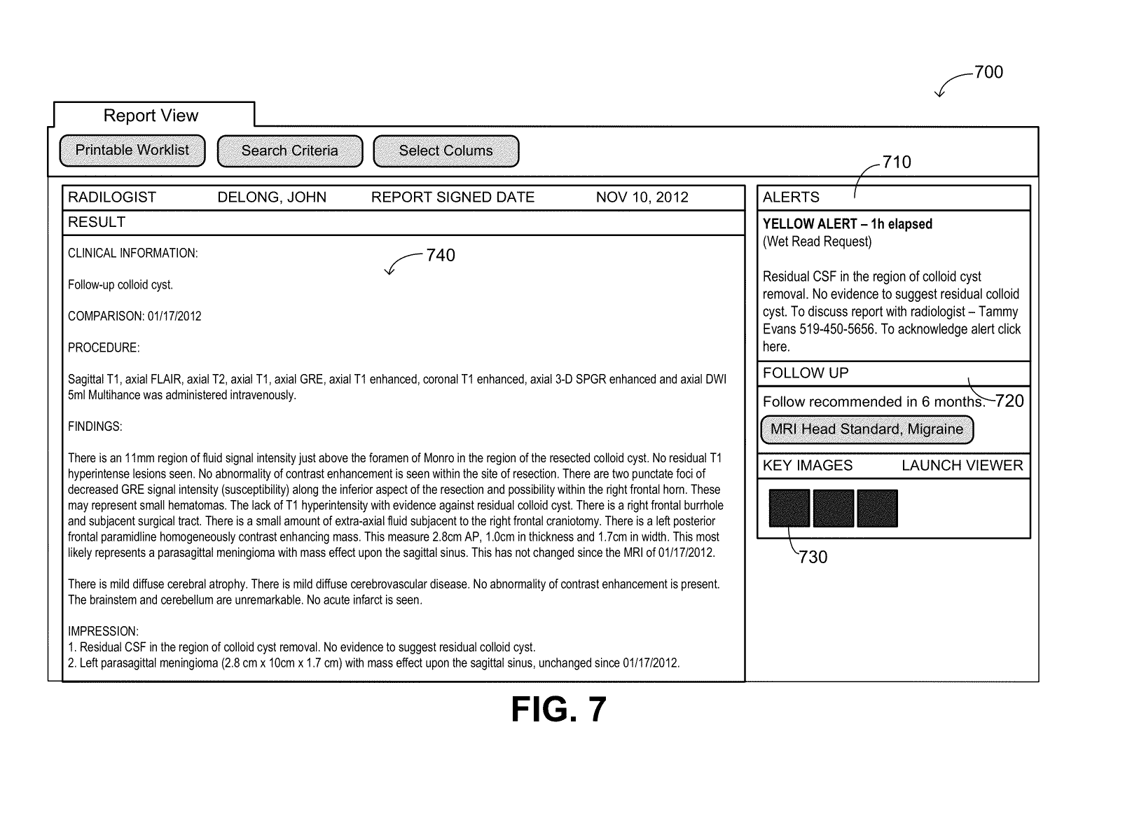

FIG. 7 is a diagram illustrating a graphical user interface 700 for displaying an actionable report of a radiology image study in accordance with some embodiments of the disclosure. In general, the graphical user interface 700 may display an actionable report from a radiologist to a referring physician.

As shown in FIG. 7, the graphical user interface 700 may display information authored or entered by a radiologist (e.g., by using buttons or icons 301, 302, and/or 303) in a results section 740. In some embodiments, the results section 740 may display clinical information, procedure, findings, and impression information associated with the radiology image study of the report. Furthermore, the graphical user interface 700 may comprise an alerts section 710 to display an alert status of the radiology image study report (e.g., as indicated from the buttons 3341, 342, 343, and 344 from the signature pad 300). Furthermore, the graphical user interface 700 may comprise a follow-up section 720 and a key images section 730. In some embodiments, the key images section 730 may comprise thumbnail images of the key images as selected by the radiologist using the signature pad 300 (e.g., from button or icon 307). In the same or alternative embodiments, the thumbnail images from the key images section 730 may be selected to show a full image of the corresponding key image.

As such, the graphical user interface 700 may display an actionable report that is the result of the radiologist using the signature pad 300 to author a radiology image study report, entering information for the radiology image study report, and signing the radiology image study report to be released to the referring physician.

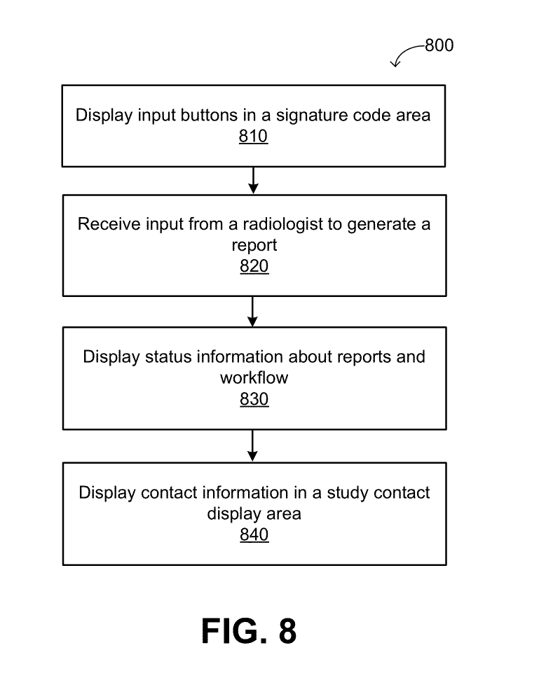

FIG. 8 illustrates an example method 800 for interacting with a user interface of a signature pad (e.g., signature pad 300) in accordance with some embodiments. As shown, at step 810, input buttons may be displayed on the user interface. For example, input buttons may be displayed in a signature code area. In some embodiments, at step 820, an input may be received from a radiologist from the input buttons. The input may result in the generation of a radiology image study report. In some embodiments, the input buttons may allow the radiologist to classify a finding of the report, generate an alert associated with the report, and generate a follow-up status for the report. At step 830, status information may be displayed with icons that may be selected to manage reports and workflow for the radiologist. Furthermore, at step 840, contact information may be displayed. For example, the contact information may display the contact information for a referring physician for a selected radiology image study report.

The systems and methods disclosed herein provide many advantages to facilitate a radiologist workflow. For example, the user interface of the signature pad may provide a plurality of functionalities associated with a radiologist in a single display or screen. For example, the user interface may be used to author radiology image study reports, view statistics of the radiologist's workflow, classify or code a radiology image study report, view contact information associated with the referring physician, and sign a radiology image study report. As such, many functions as part of a radiologist completing a work list or workflow may be performed on a single user interface.

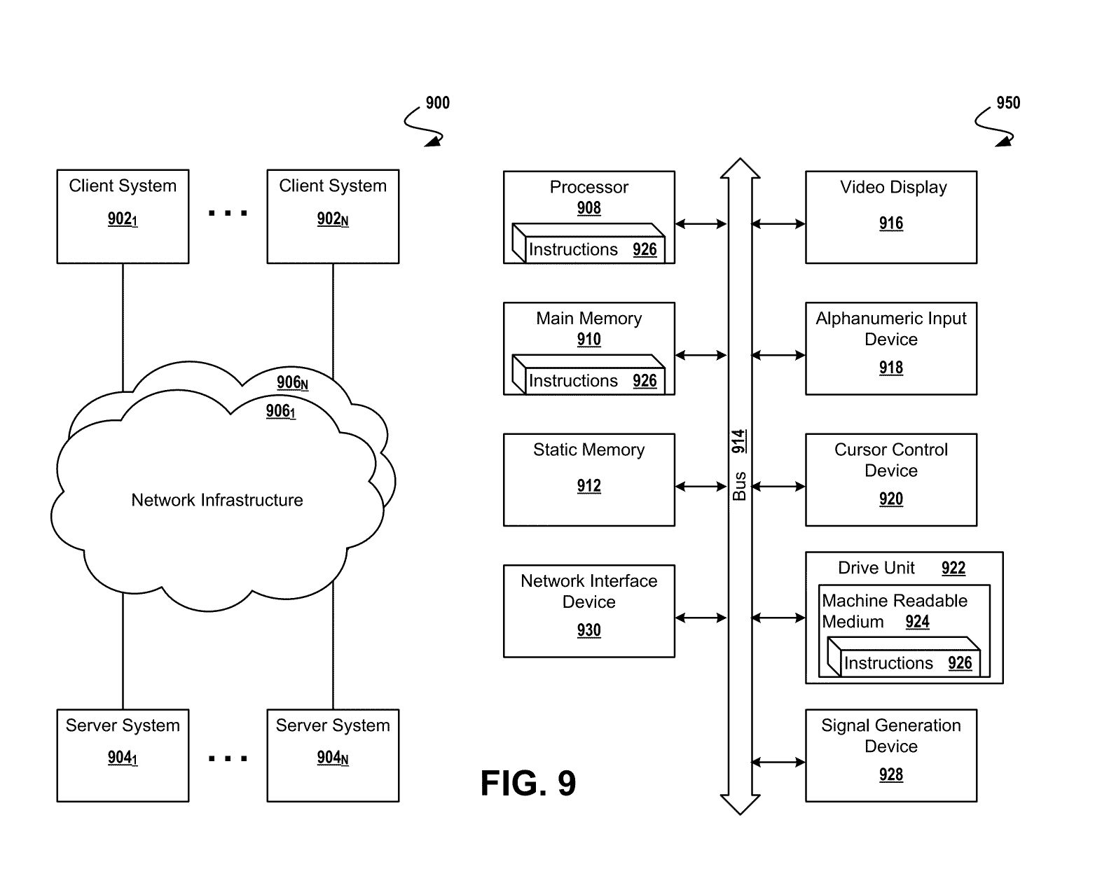

FIG. 9 depicts a diagram illustrating an exemplary computing system environment for execution of the operations comprising various embodiments of the disclosure. In some embodiments, a network 900, including nodes for client computer systems 902₁ through 902_{N}, nodes for server computer systems 904₁ through 904_{N}, nodes for network infrastructure 906₁ through 906_{N}, any of which nodes may comprise a machine 950 within which a set of instructions for causing the machine to perform any one of the techniques discussed above may be executed. The embodiment shown is purely exemplary, and might be implemented in the context of one or more of the figures herein.

Any node of the network 900 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc.).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 950 includes a processor 908 (e.g. a processor core, a microprocessor, a computing device, etc.), a main memory 910 and a static memory 912, which communicate with each other via a bus 914. The machine 950 may further include a display unit 916 that may comprise a touch-screen, or a liquid crystal display (LCD), or a light emitting diode (LED) display, or a cathode ray tube (CRT). As shown, the computer system 950 also includes a human input/output (I/O) device 918 (e.g., a keyboard, an alphanumeric keypad, etc.), a pointing device 920 (e.g., a mouse, a touch screen, etc.), a drive unit 922 (e.g. a disk drive unit, a CD/DVD drive, a tangible computer readable removable media drive, an SSD storage device, etc.), a signal generation device 928 (e.g. a speaker, an audio output, etc.), and a network interface device 930 (e.g. an Ethernet interface, a wired network interface, a wireless network interface, a propagated signal interface, etc.).

The drive unit 922 includes a machine-readable medium 924 on which is stored a set of instructions (i.e. software, firmware, middleware, etc.) 926 embodying any one, or all, of the methodologies described above. The set of instructions 926 is also shown to reside, completely or at least partially, within the main memory 910 and/or within the processor 908. The set of instructions 926 may further be transmitted or received via the network interface device 930 over the network bus 914.

It is to be understood that embodiments of this disclosure may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information. In some embodiments, software modules or hardware modules may be used to perform the system or method disclosed herein.

What is claimed is:

1. A method for interfacing a radiologist to a radiology system, comprising:
displaying, in a signature code area of a display, a plurality of input buttons for generating and signing a report for a radiology exam request;
receiving input from the input buttons by the radiologist to generate a report and to permit the radiologist to perform at least one of :
classifying a finding for the report;
generating one or more alerts associated with the report; or generating a follow-up status associated with the report;
displaying, in a stats display area of the display, at least one icon that displays status information about reports and that displays, when initiated, means to manage reports and workflow for the radiologist; and
displaying, in a study contact display area of the display, information, including contact information, for a selected report.

2. The method as set forth in claim 1, further comprising displaying a workflow navigation buttons to control navigation and input to generate a radiologist report.

3. The method as set forth in claim 1, wherein receiving input to generate a classified finding for the report comprises receiving input from the buttons from a radiologist to input to a report a finding of at least one of significant, not significant, indeterminate or normal.

4. The method as set forth in claim 1, wherein receiving input to generate one or more alerts associated with the report comprises receiving input from the buttons from a radiologist to input to a report an alert of at least one of the type of red, orange or yellow.

5. The method as set forth in claim 1, wherein receiving input to generate a follow-up status associated with the report comprises receiving input from the buttons from a radiologist to input to a report a follow-up status or a no follow-up status.

6. The method as set forth in claim 1, wherein displaying, in a stats display area, at least one icon comprises displaying a plurality of icons that each indicate a number of reports associated with a red alert, an orange alert and a yellow alert and to initiate, through the respective icons, additional information associated with the reports.

7. The method as set forth in claim 1, wherein displaying, in a stats display area, at least one icon comprises displaying a plurality of icons to display an indication for at least one of unsigned reports, wet reads, peer review or shift Relative Value Units (RVUs).

8. The method as set forth in claim 1, wherein displaying, in a study contact display area, information further comprises displaying an icon to permit access to a key image.

9. The method as set forth in claim 1, wherein displaying, in a study contact display area, information further comprises displaying at least one icon to indicate at least one of an indication for a wet read or a prelim.

10. The method as set forth in claim 1, wherein displaying, in a study contact display area, information further comprises displaying at least one icon to indicate whether a report has been acknowledged by a referring physician.

11. A non-transitory computer readable medium carrying one or more instructions for interfacing a radiologist to a radiology system, wherein the one or more instructions, when executed by one or more processors, causes the one or more processors to perform the steps of:
displaying, in a signature code area of a display, a plurality of input buttons for generating and signing a report for a radiology exam request;
receiving input from the input buttons by the radiologist to generate a report and to permit the radiologist to perform at least one of :
classifying a finding for the report;
generating one or more alerts associated with the report; or generating a follow-up status associated with the report;
displaying, in a stats display area of the display, at least one icon that displays status information about reports and that displays, when initiated, means to manage reports and workflow for the radiologist; and
displaying, in a study contact display area of the display, information, including contact information, for a selected report.

12. The non-transitory computer readable medium as set forth in claim 11, further comprising displaying a workflow navigation buttons to control navigation and input to generate a radiologist report.

13. The non-transitory computer readable medium as set forth in claim 11, wherein receiving input to generate a classified finding for the report comprises receiving input from the buttons from a radiologist to input to a report a finding of at least one of significant, not significant, indeterminate or normal.

14. The non-transitory computer readable medium as set forth in claim 11, wherein receiving input to generate one or more alerts associated with the report comprises receiving input from the buttons from a radiologist to input to a report an alert of at least one of the type of red, orange or yellow.

15. The non-transitory computer readable medium as set forth in claim 11, wherein receiving input to generate a follow-up status associated with the report comprises receiving input from the buttons from a radiologist to input to a report a follow-up status or a no follow-up status.

16. The non-transitory computer readable medium as set forth in claim 11, wherein displaying, in a stats display area, at least one icon comprises displaying a plurality of icons that each indicate a number of reports associated with a red alert, an orange alert and a yellow alert and to initiate, through the respective icons, additional information associated with the reports.

17. The non-transitory computer readable medium as set forth in claim 11, wherein displaying, in a stats display area, at least one icon comprises displaying a plurality of icons to display an indication for at least one of unsigned reports, wet reads, peer review or shift RVUs.

18. The non-transitory computer readable medium as set forth in claim 11, wherein displaying, in a study contact display area, information further comprises displaying an icon to permit access to a key image.

19. The non-transitory computer readable medium as set forth in claim 11, wherein displaying, in a study contact display area, information further comprises displaying at least one icon to indicate at least one of an indication for a wet read or a prelim.

20. The non-transitory computer readable medium as set forth in claim 11, wherein displaying, in a study contact display area, information further comprises displaying at least one icon to indicate whether a report has been acknowledged by a referring physician.

21. A radiology system, comprising:
a display device to display, in a signature code area of the display, a plurality of input buttons, to display, in a stats display area of the display, at least one icon that displays status information about reports and that displays, when initiated, means to manage reports and workflow for the radiologist, and to display, in a study contact display area of the display, information, including contact information, for a selected report; and
at least one processor and memory, coupled to the display device, to receive input from the input buttons by the radiologist to generate and sign a report for a radiology exam request, and to permit the radiologist to perform at least one of:
classify a finding for the report;
generate one or more alerts associated with the report; or
generate a follow-up status associated with the report.
